(19) United States
(12) Patent Application Publication
(10) Pub. No.: US 2022/0324758 A1
(43) Pub. Date: Oct. 13, 2022

(54) COMPOSITE PRECURSOR POWDER FOR NON-OXIDE CERAMICS AND METHOD FOR MAKING THE SAME

(71) Applicant: THE JOHNS HOPKINS UNIVERSITY, Baltimore, MD (US)

(72) Inventors: Adam B. PETERS, Baltimore, MD (US); Michael C. BRUPBACHER, Catonsville, MD (US); Dajie ZHANG, Baltimore, MD (US); Dennis NAGLE, Ellicott City, MD (US)

(21) Appl. No.: 17/765,313

(22) PCT Filed: Oct. 1, 2020
(86) PCT No.: PCT/US2020/053779

§ 371 Date: Mar. 30, 2022

Related U.S. Application Data
(60) Provisional application No. 62/909,481, filed on Oct. 2, 2019.
(60) Provisional application No. 62/966,239, filed on Jan. 27, 2020.

(51) Int. Cl. C04B 35/56; C04B 35/65; B33Y 70/10; B28B 1/00; B33Y 10/00; B33Y 80/00

(52) U.S. Cl. CPC C04B 35/5611; C04B 35/5607; C04B 35/65; B33Y 70/10; B28B 1/001; B33Y 10/00; B33Y 80/00; C04B 2235/404; C04B 2235/3241; C04B 2235/3232; C04B 2235/3843; C04B 2235/3839

(57) ABSTRACT

A composite precursor powder, including one or more metals or metalloids, and one or more oxides, wherein a molar ratio of the one or more metals or metalloids to the one or more oxides is from about 1:0.01 to about 1:4, and wherein the molar ratio of the one or more metals or metalloids to the one or more oxides is configured according to a desired volumetric change of the composite precursor powder when converted to a non-oxide ceramic.

### CROSS-REFERENCE TO RELATED APPLICATIONS

This application claims priority to U.S. Provisional Patent Application Ser. Nos. 62/909,481 and 62/966,239, filed on Oct. 2, 2019, and Jan. 27, 2020, respectively, which are incorporated by reference herein in their entirety.

### U.S. GOVERNMENT RIGHTS

The invention was made with Government support promoted by the Office of Naval Research, Nanomaterials Program Office, under contract N000014-16-1-2460. The Government has certain rights in the invention.

### TECHNICAL FIELD

The present disclosure generally relates to precursor powders, and more particularly, to composite precursor powders for non-oxide ceramic objects and methods for making the non-oxide ceramic objects.

### BACKGROUND

Precursor powders are used in 3D printing and additive manufacturing (AM) processes to create objects using layer-by-layer construction methods. For example, metal and polymer precursor powders may be used with selective laser sintering (SLS) or powder bed fusion (PBF) processes to create geometrically complex parts via sintering. Similarly, reactive precursor powders and reactant liquids or gasses may be used in selective laser reaction sintering (SLRS) to create objects by chemical conversion processes.

However, the use of AM processes to create ceramic objects, and especially non-oxide ceramic objects, such as carbides, nitrides, borides, and silicides, has been limited due to the complex processing conditions that these materials may require. For example, ceramic objects created from ceramic precursor powders may be subject to micro-cracking when the thermal shock resistances of these ceramic precursors is exceeded during the AM process. Similarly, the use of metal or oxide precursors to form ceramic objects in a reactive AM process is often also accompanied by volumetric changes during the AM process that can result in structural defects, such as cracking, excessive porosity, and interlayer delamination. While, expendable binders have been used with precursor powders to promote consolidation and mass diffusion during the AM processing, the eventual removal of the expendable binder may also result in volumetric changes and increased risk of cracking and/or other structural defects in addition to chemical inhomogeneity.

Accordingly, there is a need for precursor powders for non-oxide ceramics that can be used in AM processes while controlling or eliminating volumetric changes that may result in structural defects, such as cracking or porosity, and methods for making the precursor powders and for creating the non-oxide ceramic objects.

### BRIEF SUMMARY

This summary is intended merely to introduce a simplified summary of some aspects of one or more implementations of the present disclosure. This summary is not an extensive overview, nor is it intended to identify key or critical elements of the present teachings, nor to delineate the scope of the disclosure. Rather, its purpose is merely to present one or more concepts in simplified form as a prelude to the detailed description below.

The foregoing and/or other aspects and utilities embodied in the present disclosure may be achieved by providing a composite precursor powder, including one or more metals or metalloids; and one or more oxides, wherein a molar ratio of the one or more metals or metalloids to the one or more oxides is from about 1:0.01 to about 1:4, and wherein the molar ratio of the one or more metals or metalloids to the one or more oxides is configured according to a desired volumetric change of the composite precursor powder when converted to a non-oxide ceramic.

The molar ratio of the one or more metals or metalloids to the one or more oxides may be configured to balance a volume change of the one or more metals or metalloids when converted to a non-oxide ceramic and a volume change of the one or more oxides when converted to a non-oxide ceramic.

The molar ratio of the one or more metals or metalloids to the one or more oxides may be configured to produce a substantially isovolumetric non-oxide ceramic.

The molar ratio of one or more metals or metalloids to the one or more oxides may be configured to produce a non-oxide ceramic with one of a larger volume than the composite precursor powder and a smaller volume than the composite precursor powder.

The ratio of the one or more metals or metalloids to the one or more oxides may be one of about 21:79, 33:66, 41:59, 67:33, 84:16, 86:14, 87:13, 89:11, 90:10, 96:04: and 97:03.

A mole fraction of the one or more metals or metalloids in the composite precursor powder may be from about 0.01 to 0.99.

A mole fraction of the one or more metals or metalloids in the composite precursor powder may be one of about 0.21, 0.33, 0.41, 0.67, 0.84, 0.86, 0.87, 0.89, 0.90, 0.96, and 0.97.

The composite precursor powder may not include a binder, and the composite precursor powder may consist essentially of the one or more metals or metalloids and the one or more oxides.

The non-oxide ceramic may be a composite non-oxide ceramic.

The one or more metals or metalloids may include one or more metals encompassed by groups 2-6 and periods 2-6 of the periodic table, and the one or more oxides may include one or more oxides of a metal or metalloid encompassed by groups 2-6 and periods 2-6 of the periodic table.

At least one of the one or more oxides in the composite precursor powder may correspond to at least one of the one or more metals or metalloids.

The one or more metals or metalloids may include at least one of chromium (Cr), titanium (Ti), silicon (Si), and zirconium (Zr), and wherein the one or more oxides may include at least one of chromium oxide, titanium oxide, silicon oxide, and zirconium oxide.

The composite precursor powder may be a substantially homogenous mixture.

The one or more metals or metalloids may have an average particle size from about 100 nm to about 100 μm, the one or more oxides may have an average particle size from about 100 nm to about 100 μm, and the one or more metals or metalloids may be substantially surrounded by the oxide.

The composite precursor powder may be configured for use in selective laser reaction sintering to convert into at least one of a carbide, nitride, boride, and silicide non-oxide ceramic.

The foregoing and/or other aspects and utilities embodied in the present disclosure may also be achieved by providing a method of making a non-oxide ceramic object from a composite precursor powder, including forming a first layer of a composite precursor powder, wherein the composite powder includes one or more metals or metalloids and one or more oxides; heating the composite precursor powder in the first layer; and exposing the composite precursor powder in the first layer to a reactant gas, wherein at least a portion of the composite precursor powder in the first layer is converted to a non-oxide ceramic after being heated and exposed to the reactant gas, and wherein a molar ratio of the one or more metals or metalloids to the one or more oxides in the composite precursor powder is configured according to a desired volumetric change of the composite precursor powder when converted to the non-oxide ceramic.

The method may further include forming a second layer of the composite precursor powder over the first layer; heating the composite precursor powder in the second layer; and exposing the composite precursor powder in the second layer to the reactant gas, wherein at least a portion of the composite precursor powder in the second layer is converted to a non-oxide ceramic after being heated and exposed to the reactant gas.

The second layer of the composite precursor powder may be formed over the first layer when at least 95% of the portion of the composite precursor powder in the first layer is converted to a non-oxide ceramic.

The second layer of the composite precursor powder may be formed over the first layer when at least 80%, 90%, and/or 95% of the portion of the composite precursor powder in the first layer is converted to a non-oxide ceramic.

The second layer of the composite precursor powder may be formed over the first layer when substantially all of the portion of the composite precursor powder in the first layer is converted to a non-oxide ceramic.

The second layer of the composite precursor powder may be formed over the first layer when about 100% of the portion of the composite precursor powder in the first layer is converted to a non-oxide ceramic.

The first layer may have substantially the same volume after the first layer is converted to the non-oxide ceramic as when it was formed from the composite precursor powder.

The second layer may have substantially the same volume after the second layer is converted to the non-oxide ceramic as when it was formed from the composite precursor powder over the first layer.

The foregoing and/or other aspects and utilities embodied in the present disclosure may be achieved by providing a non-oxide ceramic object created from a composite precursor powder including one or more metals or metalloids; and one or more oxides, wherein a molar ratio of the one or more metals or metalloids to the one or more oxides is from about 1:0.01 to about 1:4, and wherein the molar ratio of the one or more metals or metalloids to the one or more oxides is configured according to a desired volumetric change of the composite precursor powder when converted to a non-oxide ceramic.

Further areas of applicability will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The accompanying drawings, which are incorporated in, and constitute a part of this specification, illustrate implementations of the present teachings and, together with the description, serve to explain the principles of the disclosure. In the figures:

FIG. 1 illustrates a volume change for a composite precursor powder according to an implementation.

FIG. 2 illustrates a volume change for a composite precursor powder according to an implementation.

FIG. 3 illustrates a system for creating non-oxide ceramic objects according to an implementation.

FIG. 4 illustrates a method for creating non-oxide ceramic objects according to an implementation.

FIG. 5 illustrates a SEM micrograph of a composite precursor powder according to an implementation.

FIG. 6 illustrates a SEM-BSE micrograph of the composite precursor powder of FIG. 5 according to an implementation.

FIG. 7 illustrates an SEM micrograph of a composite precursor powder before conversion to a non-oxide ceramic according to an implementation.

FIG. 8 illustrates an SEM micrograph of the composite precursor powder of FIG. 7 after conversion to a non-oxide ceramic according to an implementation.

FIG. 9 illustrates an SEM micrograph of a patterned Cr3C₂ sample formed from a composite precursor powder according to an implementation.

FIG. 10 illustrates a non-oxide ceramic according to an implementation.

FIGS. 11-12 illustrate a volumetric expansion of titanium-based powders.

FIG. 13 illustrates a volumetric expansion of a titanium-based composite precursor powder according to an implementation.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary implementations of the present teachings, examples of which are illustrated in the accompanying drawings. Generally, the same reference numbers will be used throughout the drawings to refer to the same or like parts.

Throughout the specification and claims, the following terms take the meanings explicitly associated herein, unless the context clearly dictates otherwise. Phrases, such as, “in an implementation,” “in certain implementations,” and “in some implementations” as used herein do not necessarily refer to the same implementation(s), though they may. Furthermore, the phrases “in another implementation” and “in some other implementations” as used herein do not necessarily refer to a different implementation, although they may. As described below, various implementations can be readily combined, without departing from the scope or spirit of the present disclosure.

As used herein, the term “or” is an inclusive operator, and is equivalent to the term “and/or,” unless the context clearly dictates otherwise. The term “based on” is not exclusive and allows for being based on additional factors not described, unless the context clearly dictates otherwise. In the specification, the recitation of “at least one of A, B, and C,” includes implementations containing A, B, or C, multiple examples of A, B, or C, or combinations of A/B, A/C, B/C, AB/B/B/B/C, AB/C, etc. In addition, throughout the specification, the meaning of “a,” “an,” and “the” include plural references. The meaning of “in” includes “in” and “on.”

It will also be understood that, although the terms first, second, etc. can be used herein to describe various elements, these elements should not be limited by these terms. These terms are only used to distinguish one element from another. For example, a first object, component, or step could be termed a second object, component, or step, and, similarly, a second object, component, or step could be termed a first object, component, or step, without departing from the scope of the invention. The first object, component, or step, and the second object, component, or step, are both, objects, component, or steps, respectively, but they are not to be considered the same object, component, or step. It will be further understood that the terms “includes,” “including,” “comprises” and/or “comprising,” when used in this specification, specify the presence of stated features, steps, operations, elements, and/or components, but do not preclude the presence or addition of one or more other features, steps, operations, elements, components, and/or groups thereof. Further, as used herein, the term “if” can be construed to mean “when” or “upon” or “in response to determining” or “in response to detecting,” depending on the context.

All physical properties that are defined hereinafter are measured at 20° to 25° Celsius unless otherwise specified.

When referring to any numerical range of values herein, such ranges are understood to include each and every number and/or fraction between the stated range minimum and maximum, as well as the endpoints. For example, a range of 0.5% to 6% would expressly include all intermediate values of, for example, 0.6%, 0.7%, and 0.9%, all the way up to and including 5.95%, 5.97%, and 5.99%, among many others. The same applies to each other numerical property and/or elemental range set forth herein, unless the context clearly dictates otherwise.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges. The terms “about” or “substantial” and “substantially” or “approximately,” with reference to amounts or measurement values, are meant that the recited characteristic, parameter, or values need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

As used herein, “free” or “substantially free” of a material or substance may refer to when the material is present in an amount small enough to have zero or negligible effects on a desired result. For example, an atmosphere may be “free” or “substantially free” or substantially free of oxygen if the amount of oxygen has at most a negligible effect. In some implementations, “free” or “substantially free” may refer to less than 20 ppm, less than 10 ppm, and less than 5 ppm, of a specific material, such as oxygen or hydrogen. In other implementations, “free” or “substantially free” may refer to less than 50 ppb, less than 30 ppb, and less than 15 ppb, of a specific material, such as oxygen or hydrogen.

Unless otherwise specified, all percentages and amounts expressed herein and elsewhere in the specification should be understood to refer to percentages by weight. The percentages and amounts given are based on the active weight of the material. For example, for an active ingredient provided as a solution, the amounts given are based on the amount of the active ingredient without the amount of solvent or may be determined by weight loss after evaporation of the solvent.

With regard to procedures, methods, techniques, and workflows that are in accordance with some implementations, some operations in the procedures, methods, techniques, and workflows disclosed herein can be combined and/or the order of some operations can be changed.

The inventors have created a new composite precursor powder for non-oxide ceramics. A composition of the composite precursor powder may be adjusted to control a volumetric change of the composite precursor powder as it is converted to a non-oxide ceramic. The composition may be adjusted in terms of molar ratio or weight percentages of the components of the composite precursor powder. The composition may be also adjusted in terms of stoichiometric ratios. For example, the composition of the composite precursor powder may be adjusted to create a substantially isovolumetric non-oxide ceramic. That is, the volume of the resulting non-oxide ceramic will be substantially equivalent to the volume of the composite precursor powder before conversion. In other implementations, the composition of the composite precursor powder may be adjusted to create a desired change in the volume of the resulting non-oxide from the volume of the composite precursor powder before conversion. For example, the composition of the composite precursor powder may be adjusted to increase or decrease a volume of the resulting non-oxide ceramic as compared to the composite precursor powder before conversion.

The composite precursor powder may include a metal or metalloid and an oxide. The oxide may correspond to the metal or metalloid. That is, the oxide may be an oxide of the metal or metalloid. For example, if the metal or metalloid is chromium (Cr), the oxide may be chromium oxide (Cr₂O₃). In other implementations, the oxide may not correspond to the metal or metalloid. That is, the oxide may be an oxide of a different metal or metalloid that the metal or metalloid in the precursor powder. For example, if the metal or metalloid is titanium (Ti), the oxide may be silicon oxide (SiO₂).

The metal or metalloid may include a plurality of metal or metalloid particles. The oxide include a plurality of oxide particles.

The metal or metalloid may include one or more metal or metalloids. The oxide may include one or more oxides. For example, the composite precursor powder may include titanium (Ti) and zirconium (Zr) as the metal or metalloids and silicon oxide (SiO₂) as the oxide. In other implementations, the composite precursor powder may include titanium (Ti) as the metal or metalloid and zirconium oxide ZrO₂and silicon SiO₂ oxide as the oxides.

The composite precursor powder may be configured for use in selective laser reaction sintering (SLRS). The metal or metalloid and the oxide may be configured to convert into a non- oxide ceramic. For example, the metal or metalloid and the oxide may be configured to convert to a non-oxide ceramic by a gas-solid SLRS process using a reactant gas. In other implementations, the metal or metalloid and the oxide may be configured to convert to a non-oxide ceramic by a gas-liquid SLRS process using a reactant gas.

The non-oxide ceramic may include one or more non-oxide ceramics. For example, the non-oxide ceramic may include one or more of carbides, nitrides, borides, and silicides. For example, the non-oxide ceramic may include chromium carbide (Cr₃C₂). In other examples, the non-oxide ceramic may include silicon carbide (SiC) and zirconium carbide (ZrC). In other example, the non-oxide ceramic may include titanium carbide (TiC), zirconium carbide (ZrC) and silicon carbide (SiC).

The reactant gas may include a carbon source, such as methane, a nitrogen source, such as NH₃ and/or N₂, a boron source, such as BH₃, and a silicon source, such as SiH₄.

The metal or metalloid may be a metal encompassed by groups 2-6 and periods 2-6 of the periodic table. For example, the metal or metalloid may be one of aluminum, titanium, vanadium, chromium, zirconium, niobium, molybdenum, tantalum, tungsten, and rhenium. Similarly, the oxide may be an oxide of a metal encompassed by groups 2-6 and periods 2-6 of the periodic table. For example, the oxide may be one of aluminum oxide, titanium oxide, vanadium oxide, chromium oxide, zirconium oxide, niobium oxide, molybdenum oxide, tantalum oxide, tungsten oxide, and rhenium oxide.

In other implementations, the metal or metalloid may also be a metalloid. For example, the metalloid may be one of silicon or boron and the oxide may be one of silicon oxide and boron oxide.

For example, the metal or metalloid may include chromium (Cr) and the oxide may include chromium oxide (Cr₂O₃); the metal or metalloid may include aluminum (Al) and the oxide may include aluminum oxide (Al₂O₃); the metal or metalloid may include titanium (Ti) and the oxide may include silicon oxide (SiO₂); the metal or metalloid may include tantalum (Ta) and the oxide may include hafnium oxide (Hf₂); and, the metal or metalloid may include silicon (Si) and the oxide may include zirconium oxide (ZrO₂).

In some implementations, the composite precursor powder consists essentially of the metal or metalloid and the oxide. For example, the composite precursor powder may consist essentially of chromium (Cr) and chromium oxide (Cr₂O₃).

As used herein, the term “consisting essentially of” is intended to mean that metal or metalloid and the oxide are the only necessary and essential ingredients of the composite precursor powder. However, the composite precursor powder may also include other ingredients that do not materially affect the basic and novel characteristics of the composite precursor powder.

In some implementations, the composite precursor powder may also include a non-oxide ceramic. The non-oxide ceramic may correspond to the metal or metalloid and/or the oxide, or the non-oxide ceramic may not correspond to the metal or metalloid and/or the oxide. That is, the non-oxide ceramic may correspond to the reaction product of the metal or metalloid and the oxide. For example, the composite precursor powder may include chromium (Cr) and chromium oxide (Cr₂O₃) and may also include chromium carbide (Cr₃C₂). In another example, the composite precursor powder may include titanium (Ti) and silicon oxide (SiO₂) and may also include titanium carbide (TiC). In yet another example, the composite precursor powder may include titanium (Ti) and silicon oxide (ZrO₂) and the composite precursor powder may also include silicon carbide (SiC).

The composite precursor powder may not include a binder and/or resin. For example, the composite precursor powder may lack organic binders, such as thermoplastics or phenols, and/or the composite precursor powder may lack inorganic binders, such as metal phosphates and metal borides.

In other implementations, the precursor powder may include a binder and/or resin and a molar ratio of the metal or metalloid to the oxide may be configured (as described below) to accommodate volumetric additional changes created by inclusion of the binder and/or resin.

In other implementations, the precursor may include a tertiary solid reactant (such as graphitic carbon) and a molar ratio of the metal or metalloid to the oxide may be configured (as described below) to accommodate additional volumetric changes created by of the solid reactant.

In order to control a volumetric change of the composite precursor powder as it is converted to a non-oxide ceramic, the composition of the composite precursor powder may be adjusted in view of the underlying reaction process. For example, a molar ratio of the metal or metalloid to the oxide may be configured according to a desired volumetric change of the composite precursor powder when converted to a non-oxide ceramic and a given reactant atmosphere (e.g. CH₄ for carbides and NH₃ for nitrides). The oxide used may be selected to correspond to the metal or metalloid used and/or according to the specific volume of the oxide. In other implementations, the oxide does not correspond to the metal or metalloid. For example, silicon (Si) and zirconium oxide (ZrO₂) may be used to form a SiC/ZrC composite material by reaction with CH₄. In other implementations, silicon oxide (SiO₂) and zirconium (Zr) may be used to form the SiC/ZrC composite material CH₄.

Accordingly, in some implementations, the non-oxide ceramic may be implemented as a composite non-oxide ceramic including two or more non-oxide ceramics. For example, the non-oxide ceramic may be implemented as a SiC/ZrC composite non-oxide ceramic. In other implementations, the non-oxide ceramic includes only one non-oxide ceramic, such as chromium carbide.

Generally, the conversion of a metal or metalloid (M) to the non-oxide ceramic is associated with a volume expansion, while conversion of the oxide (MO) to the non-oxide ceramic is associated with a volume reduction. Accordingly, the fractional volume change associated with a particular M/MO precursor composition, may be adjusted as follows to achieve a desired volumetric change. This remains true whether the metal or metalloid (M) corresponds or does not correspond to the oxide (MO). That is, whether the oxide (MO) has the same base atom (e.g. Si in Si or SiO₂) or has different base atoms (e.g. Si in Si or Ti in TiO₂) that the metal or metalloid (M). As such, metals (M) and oxides (MO) may be selected independently to form a composite precursor powder for a single or composite non-oxide ceramic, and the composition of the composite precursor powder may be adjusted for the desired volume change, whether the metal or metalloid (M) corresponds or does not correspond to the oxide (MO).

For example, in order to yield a substantially isovolumetric non-oxide ceramic from the composite precursor powder, an optimized ratio of the metal or metalloid (M) and the oxide (MO) may be used. During the conversion from composite precursor powder to non-oxide ceramic, the volumetric changes associated with the metal or metalloid (M) may be balanced with the volumetric changes associated with the oxide (MO) to obtain a substantially isovolumetric non-oxide ceramic object. Similarly, larger or smaller final volumes in the non- oxide ceramic may be achieved by adjusting the molar ratio of the metal or metalloid to the oxide.

That is, the inventors have surprisingly discovered that by controlling the ratio of the composite precursor powder constituents for a given M/MO system and reactant atmosphere isovolumetric conversion to the product non-oxide ceramic may be achieved. In other implementations, the degree of volumetric conversion may also be controlled by controlling the ratio of the composite precursor powder constituents for a given M/MO system and reactant atmosphere.

To illustrate this, consider the reaction of a composite precursor powder including a metal (M) and a metal-oxide (MₚO_{q}) with a gas, such as methane, to form a carbide ceramic (MCₓ) as represented in formulas (1) and (2) below:

M₍ₛ₎+xCH_{4(g)}→MCₓ₍ₛ₎+2xH_{2(g)} (1)

MₚO_{q(s)}+yCH_{4(g)}→pMCₓ₍ₛ₎+qCO_{(g)}+2yH_{2(g)} (2)

where y=px+q.

By computing a volume change per mol of metal (M) based on formulas (1) and (2), the fractional volume change of the metal/metal-oxide system can be expressed as represented in formulas (3) below:

$$\frac{Δ {V}_{t o t a l}}{{V}_{o}} = \frac{f ( {v}_{m c} - {v}_{m} ) + ( 1 - f ) ( p {v}_{m c} - {v}_{m o} )}{f {v}_{m} + ( 1 - f ) {v}_{m o}} \qquad ( 3 )$$

where ν_{mc} is the molar volume of the carbide (expressed per mole of MCₓ), νₘₒ is the molar volume of the metal oxide, νₘ is the molar volume of the metal, and f is the mole fraction of the metal in the composite precursor powder.

While not bound by any particular theory, the inventors believe that all molar volumes are intrinsic properties and are not dependent on any attendant porosity of the composite precursor powder. Accordingly, the effect of molar fraction on the overall volume change during formation of the non-oxide ceramic resulting from when

$$\frac{Δ {V}_{t o t a l}}{{V}_{o}}$$

can be plotted as a function off and, based on formula (3), the value of f that results in zero volume change may be expressed as follows:

$${f}_{Δ V = 0} = \frac{{v}_{m o} - p {v}_{m c}}{{v}_{m o} + ( 1 - p ) {v}_{m c} - {v}_{m}} \qquad ( 4 )$$

Accordingly, the molar ratio of the metal or metalloid to the oxide may be configured to balance a volume change of the metal or metalloid when converted to a non-oxide ceramic and a volume change of the oxide when converted to a non-oxide ceramic. For example, the molar ratio of the metal or metalloid to the oxide may be configured to produce a substantially isovolumetric non-oxide ceramic. In some implementations, the molar ratio of the metal or metalloid to the oxide may be configured to produce a non-oxide ceramic with a larger volume than the composite precursor powder. In other implementations, the molar ratio of the metal or metalloid to the oxide may be configured to produce a non-oxide ceramic with a smaller volume than the composite precursor powder.

To illustrate a volumetric change for a composite non-oxide ceramic, consider the reaction of a composite precursor powder including a metal (M^{a}) and a metal-oxide (M^{b}ₚO_{q}) with methane to form a carbide ceramic (MCₓ) as represented in formulas (5) and (6) below:

(5) M^{a}₍ₛ₎+xCH_{4(g)}→M^{a}Cₓ₍ₛ₎+2xH_{2(g)} (5)

Mₚ^{b}O_{q(s)}+yCH_{4(g)}→pM^{b}Cₓ₍ₛ₎+qCO_{(g)}+2yH_{2(g)} (6)

where y=px+q.

By computing a volume change per mol of metal (M^{a}) based on formulas (5) and (6), the fractional volume change of the metal/metal-oxide system can still be expressed as represented in formulas (4) above.

While not bound by any particular theory, the inventors believe that all molar volumes are intrinsic properties and are not dependent on any attendant porosity of the composite precursor powder. Accordingly, the effect of molar fraction on the overall volume change during formation of the non-oxide ceramic resulting from when

$$\frac{Δ {V}_{t o t a l}}{{V}_{o}}$$

can be plotted as a function of f, and, based on formula (3), the value of f that results in zero volume change may be expressed as follows in formula 7:

$${f}_{Δ V = 0} = \frac{{v}_{m o} - p {v}_{m c}}{{v}_{m o} + ( 1 - p ) {v}_{m c} - {v}_{m}} \qquad ( 7 )$$

Accordingly, a composite precursor powder for a composite non-oxide ceramic material (M^{a}C/M^{b}C) may be used to produce a substantially isovolumetric composite non-oxide ceramic in some iterations or a composite non-oxide ceramic with a larger or smaller volume than the composite precursor material.

The molar ratio of the metal or metalloid to the oxide may be from about 1:0.01 to about 1:4. For example, the molar ratio of the metal or metalloid to the oxide may be from about 1:0.02 to about 1:4, from about 1:0.02 to about 1:3, from about 1:0.02 to about 1:2, and from about 1:0.02 to about 1:1. In other implementations, the molar ratio of the metal or metalloid to the oxide may be from about 1:0.01 to about 1:1, from about 1:0.02 to about 1:1, from about 1:0.05 to about 1:1, from about 1:0.10 to about 1:1, from about 1:0.15 to about 1:1, from about 1:0.20 to about 1:1, from about 1:0.50 to about 1:1, from about 1:0.10 to about 1:1.5, from about 1:0.10 about 1:2, and from about 1:0.10 to about 1:4.

In some implementations, the ratio of the metal or metalloid to the oxide may be one of about 21:79, 33:66, 41:59, 67:33, 84:16, 86:14, 87:13, 89:11, 90:10, 96:04: and 97:03.

In another implementation, the mole fraction of the metal or metalloid in the composite precursor powder is from about 0.10 to 0.99. For example, the mole fraction of the metal or metalloid in the composite precursor powder may be from about 0.20 to about 0.99, from about 0.30 to about 0.99, from about 0.40 to about 0.99, from about 0.50 to about 0.99, from about 0.60 to about 0.99, from about 0.70 to about 0.99, from about 0.80 to about 0.99, from about 0.80 to about 0.95, from about 0.85 to about 0.95, and from about 0.85 to about 0.90.

In some implementations, the mole fraction of the metal or metalloid in the composite precursor powder is one of about 0.21, 0.33, 0.41, 0.67, 0.84, 0.86, 0.87, 0.89, 0.90, 0.96, and 0.97.

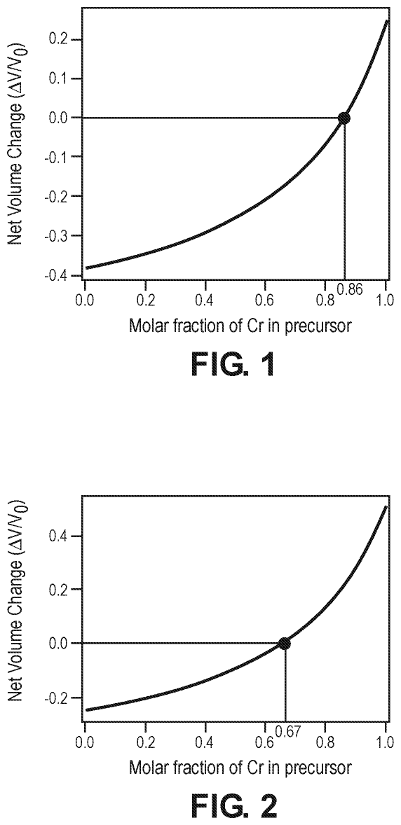

FIG. 1 illustrates a volume change for a composite precursor powder according to an implementation. In particular, FIG. 1 illustrates an overall volume change during conversion of chromium (Cr) and chromium oxide (Cr₂O₃) composite precursor powder into a chromium carbide (Cr₃C₂) by a solid-gas reaction with methane (CH₄) according to the Cr molar fraction as an example of formula (3) described above.

Based on formulas (1-4) above, the volume reduction associated with the conversion of chromium oxide (Cr₂O₃) (29.12 cm3/mol) to chromium carbide (Cr₃C₂) (26.95 cm3/mol) may be represented by formula (5) below:

3Cr₂O₃₍ₛ₎+13CH_{4(g)}→2Cr₃C₂₍ₛ₎+9CO_{(g)}+26H_{2(g)} (8)

Using ideal densities for the solid reactants and products, the volume change for formula (5) may be represented by formula (6) below:

Δ_{Cr2O3→(2/3)Cr3C2}=−11.15 cm/mol (9)

Similarly, the conversion of chromium metal (Cr) (7.23 cm3/mol) to chromium carbide (Cr₃C₂) (26.95 cm3/mol) and the associated change in volume can be represented by formulas (7-8) below:

3Cr₍ₛ₎+2CH_{4(g)}→Cr₃C₂₍ₛ₎+4H_{2(g)} (10)

ΔV_{Cr→(1/3)Cr3C2}=1.75 cm/mol (11)

As illustrated in FIG. 1, curve f illustrates a net volume change according to a change in the Cr molar fraction, with a zero change in volume when the Cr molar fraction is 0.86 (i.e. a molar ratio of 86/14 Cr/Cr₂O₃).

Accordingly, in order to achieve a zero change in volume when the composite precursor powder is converted to a carbide, the composite precursor powder may include chromium (Cr) and chromium oxide (Cr₂O₃) and the molar ratio of chromium (Cr) and chromium oxide (Cr₂O₃) may be about 86/14 Cr/Cr₂O₃.

While FIG. 1 and formulas (5-8) are illustrated with respect to a composite precursor powder including chromium (Cr) and chromium oxide (Cr₂O₃) for conversion into a chromium carbide (Cr₃C₂) by a solid-gas reaction with methane (CH₄), the present disclosure is not limited thereto. As described above, formulas (1-4) may be adapted to various metal or metalloids and various oxides, and may include a variety of reactant gases (e.g. CH₄ for carbides, NH₃ for nitrides, BH₃ for borides, and SiH₄ for silicides) according to the desired non-oxide ceramic (e.g. carbide, nitride, boride, and silicide). Similarly, formulas (1-4) may be adapted for liquid-gas reactions or a solid/liquid-gas reaction. Values for associated volume changes in formulas (9) and (11) may vary slightly to account for variations in Cr or Cr₂O₃ liquid phase density. Typically, the density of liquid phase metals or metalloids (M) and metal oxides (MO) is temperature dependent and is slightly greater than that of the solid phase.

For example, formulas (9-11) illustrate a general expression for nitride formation using NH₃, where MN is the metal nitride:

$${M}_{( s )} + x N {H}_{3 ( g )} \to M {N}_{x ( s )} + 3 / 2 {xH}_{2 ( g )} \qquad ( 12 )$$

$${M}_{q} {O}_{p ( s )} + y N {H}_{3 ( g )} \to {}_{p}^{} {MN}_{x ( s )}^{} + 3 / 2 y {H}_{2} O ( + Decomposition {Products}_{( g )} ) \qquad ( 13 )$$

$$\frac{Δ {V}_{total}}{{V}_{o}} = \frac{f ( {v}_{m n} - {v}_{m} ) + ( 1 - f ) ( p {v}_{m n} - {v}_{m o} )}{f {v}_{m} + ( 1 - f ) {v}_{m o}} \qquad ( 14 )$$

Where the value of f that results in zero volume change may be expressed as formula (12) as follows:

$${f}_{Δ V = 0} = \frac{{v}_{m o} - p {v}_{m n}}{{v}_{m o} + ( 1 - p ) {v}_{m n} - {v}_{m}} \qquad ( 15 )$$

Examples of nitride formation that can be used with formulas (9-12), include:

2Cr₍ₛ₎+2NH_{3(g)}→CrN₍ₛ₎+3H_{2(g)} (16)

Cr₂O₃₍ₛ₎+2NH₃(g)→2CrN₍ₛ₎+3H₂O_{(g)} (17)

and

4Cr₍ₛ₎+2NH_{3(g)}→Cr₂N₍ₛ₎+3H_{2(g)} (18)

2Cr₂O₃₍ₛ₎+4NH_{3(g)}2Cr₂N₍ₛ₎+6H₂O_{(g)}+2N₂ (19)

For example, based on formulas above, the volume reduction associated with the conversion of chromium oxide (Cr₂O₃) (29.12 cm3/mol) to chromium nitride (CrN) (10.89 cm3/mol) may be represented by formula (5) below:

Cr₂O₃₍ₛ₎+2NH₃(g)→2CrN₍ₛ₎+3H₂O_{(g)} (20)

Using ideal densities for the solid reactants and products, the volume change for formula (17) may be represented by formula (18) below:

ΔV_{Cr2O3→(2)CrN}=−7.33 cm/mol (21)

Similarly, the conversion of chromium metal (Cr) (7.23 cm3/mol) to chromium nitride (CrN) (10.89 cm3/mol) and the associated change in volume can be represented by formulas (19-20) below:

2Cr₍ₛ₎+2NH₃(g)→CrN₍ₛ₎+3H_{2(g)} (22)

ΔV_{Cr→CrN}=3.66 cm/mol (23)

FIG. 2 illustrates a volume change for a composite precursor powder according to an implementation. In particular, FIG. 2 illustrates an overall volume change during conversion of chromium (Cr) and chromium oxide (Cr₂O₃) composite precursor powder into a chromium nitride (Cr₃N) by a solid-gas reaction with ammonia (NH₃) according to the Cr molar fraction as an example of formula (11) described above. As illustrated in FIG. 2, curve f illustrates a net volume change according to a change in the Cr molar fraction, with a zero change in volume when the Cr molar fraction is 0.67 (i.e. a molar ratio of 67/33 Cr/Cr₂O₃).

Accordingly, in order to achieve a zero change in volume when the composite precursor powder is converted to a nitride, the composite precursor powder may include chromium (Cr) and chromium oxide (Cr₂O₃) and the molar ratio of chromium (Cr) and chromium oxide (Cr₂O₃) may be about 67/33 Cr/Cr₂O₃.

Similarly, formulas (21-24) illustrate a general expression for boride formation using BH₃, where MB is the metal boride:

$${M}_{( s )} + x B {H}_{3 ( g )} \to {MB}_{x ( s )} + 3 / 2 {xH}_{2 ( g )} \qquad ( 24 )$$

$${M}_{q} {O}_{p ( s )} + {yBH}_{3 ( g )} \to {}_{p}^{} {MN}_{x ( s )}^{} + 3 / 2 y {H}_{2} O ( + Decompositon {Production}_{( g )} ) \qquad ( 25 )$$

$$\frac{{Δ V}_{t o t a l}}{{V}_{o}} = \frac{f ( {v}_{m b} - {v}_{m} ) + ( 1 - f ) ( p {v}_{m b} - {v}_{m o} )}{f {v}_{m} + ( 1 - f ) {v}_{m o}} \qquad ( 26 )$$

$${f}_{Δ V = 0} = \frac{{v}_{m o} - p {v}_{m b}}{{v}_{m o} + ( 1 - p ) {v}_{m b} - {v}_{m}} \qquad ( 27 )$$

Examples of boride formation that can be used with formulas (21-24), include:

Zr₍ₛ₎+2BH_{3(g)}→ZrB₂+3H_{2(g)} (28)

ZrO₂₍ₛ₎+4BH_{3(g)}→2ZrB₂+6H₂O_{(g)} (29)

Formulas (27-30) illustrate a general expression for silicide formation using SiH₄, where MS is the metal silicide:

$${M}_{( s )} + x S i {H}_{4 ( g )} \to M S {i}_{x ( s )} + 2 x {H}_{2 ( g )} \qquad ( 30 )$$

$${M}_{q} {O}_{p ( s )} + y S i {H}_{4 ( g )} \to {}_{p}^{} {MN}_{x ( s )}^{} + 3 / 2 y {H}_{2} O ( + Decompositon {Production}_{( g )} ) \qquad ( 31 )$$

$$\frac{Δ {V}_{t o t a l}}{{V}_{o}} = \frac{f ( {v}_{m s} - {v}_{m} ) + ( 1 - f ) ( p {v}_{m s} - {v}_{m o} )}{f {v}_{m} + ( 1 - f ) {v}_{m o}} \qquad ( 32 )$$

$${f}_{Δ V = 0} = \frac{{v}_{m o} - p {v}_{m s}}{{v}_{m o} + ( 1 - p ) {v}_{m s} - {v}_{m}} . \qquad ( 33 )$$

Examples of silicide formation that can be used with formulas (27-30), include:

Ti₍ₛ₎+SiH_{4(g)}→TiSi₂+2H_{2(g)} (34)

TiO₂₍ₛ₎+2SiH_{4(g)}→2TiSi₂+2H₂O_{(g)}+2H₂ (35)

Formulas (36-39) illustrate an exemplary expression for balancing the volume change associated with a composite titanium carbide (TiC)/silicon carbide (Sic) non-oxide ceramic using CH₄ as explained with respect to formulas (5-6) above:

Ti+CH₄→TiC+2H₂ (ΔV_{Ti→TiC}=−1.51 cm/mol) (36)

and

SiO₂+3CH₄→SiC+2CO+6H₂ (ΔV_{SiO2→SiC}=−10.17 cm/mol) (37)

or

Si+CH₄→SiC+H₂ (ΔV_{Si→SiC}=0.39 cm/mol) (38)

and

TiO₂+3CH₄→TiC+2CO+6H₂ (ΔV_{TiO2→TiC}=−6.75 cm/mol) (39)

Formulas (40-41) illustrate an exemplary expression for balancing the volume change associated with a titanium carbide (TiC) non-ceramic oxide under a gas-liquid reaction of a Ti/TiO₂ composite precursor powder with using CH₄ as explained with respect to formulas (5-6) above:

Ti₍ₗ₎+CH₄→TiC₍ₛ₎+2H₂ (ΔV_{TiO2→TiC}=0.53 cm/mol) (40)

and

TiO₂₍ₗ₎+3CH₄→TiC₍ₛ₎+2CO+6H₂ (ΔV_{TiO2→TiC}=−11.99 cm/mol) (41)

Formulas (40-41) assume a Ti liquid density of 4.13 g/cm³ and TiO₂ liquid density of 3.31 g/cm³ at 1600 C. Formulas (40-41) result in a roughly 0.96 isovolumetric reaction upon solidification from the liquid state to the solid carbide.

Formulas (42-43) illustrate an exemplary expression for balancing the volume change associated with a silicon carbide (SiC) non-ceramic oxide under a gas-liquid reaction of a Si/SiO₂ composite precursor powder with using CH₄ as explained with respect to formulas (5-6) above:

Si(l)+CH₄→SiC(s)+H₂(ΔV_{Si→SiC}=−0.74 cm/mol) (42)

and

(43) (43)

Formulas (42-43) assume a Si liquid density of 2.39 g/cm³ and SiO₂ liquid density of 2.28 g/cm³ at 1600 C. Formulas (42-43) result in a roughly 0.95 isovolumetric reaction upon solidification from the liquid state to the solid carbide.

Metals melt at generally lower temperatures than corresponding oxide materials. This approach can be used to singularly melt the lower melting point phase while leaving the secondary material solid. That is, allowing the metal or metalloid to melt while maintaining the oxide in a solid state. This allows for consolidation of the precursor composite powder without additional thermal stresses imposed by high temperatures as illustrated in formulas (44-45) below:

Ti(l)+CH₄→TiC(s)+2H₂ (ΔV_{Ti→TiC}=0.53 cm/mol) (44)

and

TiO₂₍ₛ₎+3CH₄→TiC(s)+2CO+6H₂ (ΔV_{TiO2→TiC}=−6.74 cm/mol) (45)

Formulas (44-45) result in a rough estimate for the gas-liquid/solid isovolumetric reaction of the M₍ₗ₎/MO precursor to be ˜0.92 upon solidification from the semi-liquefied state to the solid carbide.

Table 1 illustrates various metal or metalloid mole fractions for isovolumetric conversion of a composite precursor powder to a non-oxide ceramic according to implementations of the present disclosure.

TABLE 1

| | | | Metal Mol |
|---|---|---|---|
| | | | Fraction For |
| Non-Oxide | Metal/Metal | Reactant | isovolumetric |
| Ceramic | Oxide | Gas | conversion |
| Cr₃C₂ | Cr/Cr₂O₃ | CH₄ | 0.86 |
| WC | W/WO₂ | CH₄ | 0.87 |
| TiC | Ti/TiO₂ | CH₄ | 0.84 |
| SiC | Si/SiO₂ | CH₄ | 0.97 |
| SiC | Si/SiO | CH₄ | 0.94 |
| TaC | Ta/Ta₂O₅ | CH₄ | 0.84 |
| HfN | Hf/HfO₂ | NH₃ | 0.96 |
| AlN | Al/Al₂O₃ | NH₃ | 0.21 |
| ZrN | Zr/ZrO₂ | NH₃ | 0.90 |
| TiN | Ti/TiO2 | NH₃ | 0.85 |
| ZrC | Zr/ZrO2 | CH₄ | 0.79 |
| CrN | Cr/Cr₂O₃ | NH₃ | 0.67 |
| CrN₂ | Cr/Cr₂O₃ | NH₃ | 0.89 |
| Si₃N₄ | Si/SiO2 | NH₃ | 0.76 |
| Si₃N₄ | Si/SiO | NH₃ | 0.71 |
| ZrB₂ | Zr/ZrO₂ | BH₃ | 0.41 |
| MoSi₂ | Mo/MoO₃ | SiH₄ | 0.33 |

Table 2 illustrates various metal or metalloid mole fractions for isovolumetric conversion of a composite precursor powder to a composite non-oxide ceramic according to implementations of the present disclosure.

TABLE 2

| | | | Metal Mol |
|---|---|---|---|
| Composite | | | Fraction For |
| Non-Oxide | Metal/Metal | Reactant | isovolumetric |
| Ceramic | Oxide | Gas | conversion |
| TiC/SiC | Ti/SiO₂ | CH₄ | 0.79 |
| ZrC/SiC | Zr/SiO₂ | CH₄ | 0.87 |
| ZrC/SiC | Si/ZrO₂ | CH₄ | 0.89 |
| TiC/SiC | Si/TiO₂ | CH₄ | 0.94 |
| HfC/TaC | Hf/ZrO₂ | CH₄ | 0.95 |
| HfC/TaC | Zr/HfO₂ | CH₄ | 0.80 |
| Si₃N₄/TiN | Si/TiO₂ | NH₃ | 0.82 |
| Si₃N₄/TiN | Ti/SiO₂ | NH₃ | 0.74 |

The composite precursor powder may be a substantially homogenous mixture. For example, the metal or metalloid may be well mixed within the oxide. In some implementations, the metal or metalloid may be substantially surrounded by the oxide. The oxide may include a plurality of oxide particles and the oxide may fully or partially surround the metal or metalloid. The metal or metalloid may include a plurality of metal or metalloid particles and the metal or metalloid particles may fully or partially surrounded by the oxide.

The composite precursor powder may have an average particle size from about 100 nm to about 100 μm. In some implementations, the composite precursor powder may have an average particle size from about 1 μm to about 20 μm. For example, the composite precursor powder may have an average particle size of about 100 μm or less, of about 20 μm or less, or of about 5 μm or less.

The metal or metalloid may have an average particle size from about 100 nm to about 100 μm. In some implementations, the metal or metalloid may have an average particle size from about 5 μm to about 20 μm. For example, the metal or metalloid may have an average particle size of about 100 μm or less, of about 50 μm or less, of about 20 μm or less or of about 5 μm or less.

The oxide may have an average particle size from about 100 nm to about 100 μm. In some implementations, the oxide may have an average particle size from about 100 nm to about 5 μm or from about 100 nm to about 1 μm. For example, the oxide may have an average particle size of about 5 μm or less, of about 1 μm or less, of about 500 nm or less, or of about 100 nm or less.

In some implementations, a particle size ratio of the metal or metalloid to the oxide is from about 20:1 to about 0.05:1. For example, a particle size ratio of the metal or metalloid to the oxide may be about 7:1, but may be varied according to processing specifications.

In some implementations, the unit cell, crystal structure/space group, or lattice parameter of a non-oxide within a composite precursor powder may be similar to each other to enhance bonding. For example, in a composite precursor powder including Ti/SiO₂ and/or Si/TiO₂ for a TiC/ZrC composite non-oxide ceramic, the unit cell of TiC is cubic with a space group of Fm-3m, and a lattice parameter of approximately 3.1 angstroms; the unit cell of ZrC is cubic with a space group of Fm-3m and a lattice parameter of approximately 3.3 angstroms. Such crystallographic symmetry may allow for favorable mixing of the components of the composite precursor powder and enhance useful mechanical properties thereof.

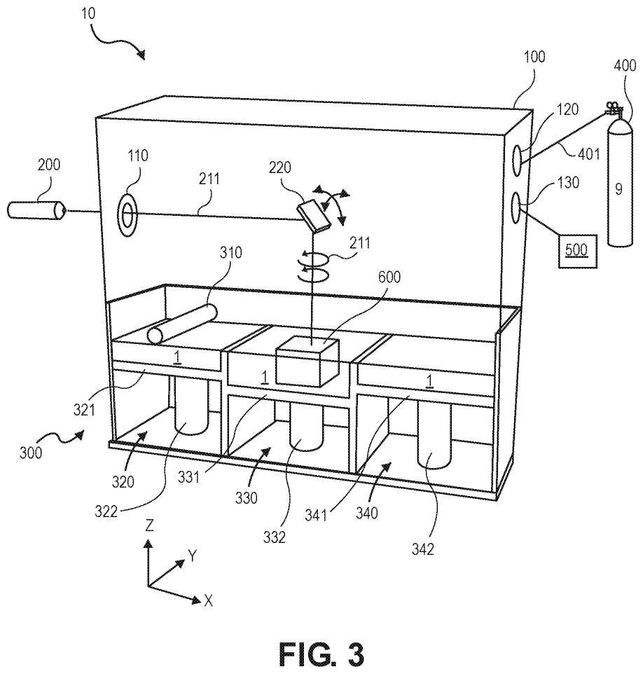

FIG. 3 illustrates a system for creating non-oxide ceramic objects according to an implementation. As illustrated in FIG. 3, a system 10 for creating non-oxide ceramic objects may include a reaction chamber 100, a laser source 200, a depositor 300, and a reactant gas source 400.

The laser source 200 may include a laser 210, a mirror 220, and one or more lenses 230.

The laser 210 may be configured to supply a laser beam 211 to the system 10. The mirror 220 may be configured to reflect and direct the laser beam 211 to a composite precursor powder 1 held in the depositor 300. The mirror 220 may be configured to guide the laser beam 211 along the x and y axis and may be disposed within the reaction chamber 100 at a position over the composite precursor powder 1. The one or more lenses 230 may be configured to focus and/or concentrate the laser beam 211 and may be disposed within the reaction chamber 100 along a path of the laser beam 211.

The reaction chamber 100 may include a laser port 110 configured to allow a laser beam 211 to enter the reaction chamber 100.

The reaction chamber 100 may include a reactant gas inlet 120 configured to allow a reactant gas 410 to enter the reaction chamber 100 and a gas outlet 120 configured to allow an atmosphere within the reaction chamber 100 to exit the reaction chamber 100. In some implementations, the system 10 includes a vacuum source 500. The vacuum source 500 may be connected to the outlet 120 and may be configured to evacuate an atmosphere from the reaction chamber 100.

The depositor 300 may be configured to supply a composite precursor powder 1 to the system 10. The depositor 300 may include a roller or blade 310, a supply portion 320, a powder bed portion 330, and an excess portion 340. As illustrated in FIG. 3, the depositor 300 may be implemented as a powder bed depositor configured to form a thin powder bed of the composite precursor powder 1 using a roller or blade 310.

The supply portion 320 may be configured to hold a supply of the composite precursor powder 1. For example, the supply portion 320 may include a supply bed 321 and a supply piston 322. The supply piston 322 may be configured to hold the supply bed 321 at a position relative to the roller or blade 310. That is, the roller or blade 310 may be configured to spread a thin layer of the composite precursor powder 1 from the supply portion 320 to the powder bed portion 330, and the supply piston 322 may be configured to move the supply bed 321 to continually refresh a supply of the composite precursor powder 1 to the roller or blade 310.

The powder bed portion 330 may be configured to receive the composite precursor powder 1 from the supply portion 320. The powder bed portion 330 may include a powder bed 331 configured to hold the composite precursor powder 1 received form the supply portion 320 and a powder bed piston 332. The powder bed piston 332 may be configured to move the powder bed 331 downwards as a supply of the composite precursor powder 1 is provided by the supply portion 320 and the roller or blade 310. For example, similar to other SLS (selective laser sintering) systems, a non-oxide ceramic object 600 is created layer by layer from exposing the thin film of composite precursor powder 1 to a heat source (provided by the laser source 200) and a reactant gas (provided by the reactant gas source 400). A first layer of the composite precursor powder 1 may be exposed to heat and a reactant gas to form a layer of the non-oxide ceramic object 600. As each layer of the non-oxide ceramic object 600 is formed, the powder bed 331 may be lowered and a new thin film of composite precursor powder 1 may be formed over the layer of the non-oxide ceramic 600.

The excess portion 340 may include an excess bed 341 and an excess piston 342. The excess bed 341 may be configured to hold an excess composite precursor powder 1. For example, as the roller or blade 310 forms a thin film of composite precursor powder 1 over the powder bed 331, any excess composite precursor powder 1 may be push to the excess bed 341. The excess piston 342 may be configured to move the excess bed 341 up or down to ensure that a correct thickness of the thin film of composite precursor powder 1 is formed over the powder bed 331.

In some implementations, at least one of the supply portion 320, the powder bed portion 330, and the excess portion 340 may include a heater configured to heat and/or pre-heat the composite precursor powder 1. For example, at least one of the supply bed 321, the powder bed 331, and the excess bed 341 may be heated to heat and/or pre-heat the composite precursor powder 1.

While the system 10 in FIG. 3 is illustrated with a powder bed depositor 300, the present disclosure is not limited thereto, and other method and apparatus to supply the composite precursor powder 1 to the system 10 may be envisioned. For example, the depositor 300 may be implemented as a slurry and/or spray deposition system configured to deposit a thin layer of the composite precursor powder 1.

The reactant gas source 400 is configured to provide a reactant gas 401 to the reaction chamber 100. In some implementations, the reactant gas source 400 is also configured to provide a non-reactive gas 402, such as argon, to the reaction chamber 100 to purge the reaction chamber 100. In some implementations, the reactant gas 401 is continuously supplied throughout the conversion process.

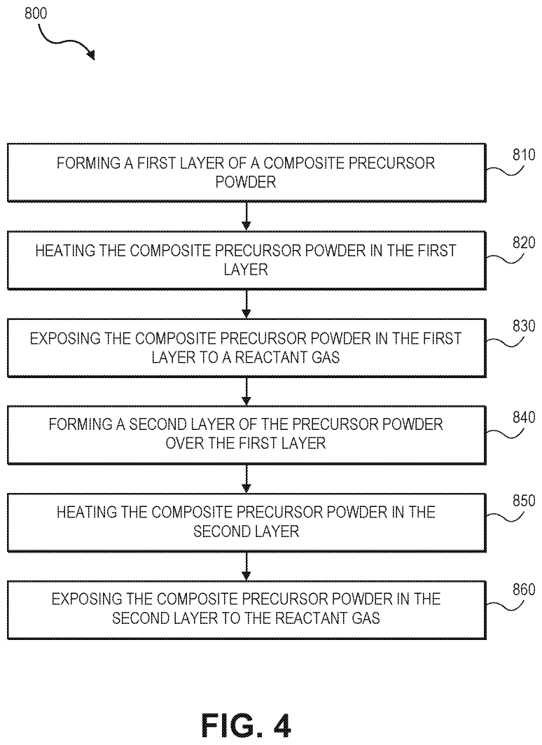

FIG. 4 illustrates a method for creating non-oxide ceramic objects according to an implementation. FIG. 4 illustrates an example of a method that, for instance, could be used to create a non-oxide ceramic object 600 using the composite precursor powders of the present disclosure, as described above. As illustrated in FIG. 4, a method 800 may be described with respect to the system 10 of FIG. 3.

It should be understood that for this and other processes and methods disclosed herein, the method of FIG. 4, show functionality and operation of one or more possible implementations of the present disclosure. In this regard, each block in the method of FIG. 4 may represent a module, segment, or portion of a program code, which includes one or more instructions executable by a processor for implementing or causing specific logical functions or steps in the process. Alternative implementations are included within the scope of the implementations of the present disclosure, in which function may be executed out of order from that shown or discussed, including substantially concurrently, depending on the functionality involved, as would be understood by those reasonably skilled in the art.

As illustrated in FIG. 4, a method 800 for making a non-oxide ceramic object may begin with forming a first layer of a composite precursor powder in operation 810.

The first layer may be formed on a substrate. The substrate may configured for extreme environments, including corrosive, high pressure, and/or high temperature environments.

The substrate may configured to reduce or eliminate thermally-induced stresses that can arise during formation or cooling of the non-oxide ceramic object. For example, the substrate may have a thermal expansion coefficient similar to that of the non-oxide ceramic object. The substrate may include austenitic nickel-chromium-based alloys, such as Inconel 600, for the formation of Cr₃C₂.

As illustrated in FIG. 3, the first layer may also be formed within a reaction chamber 100. For example, the reaction chamber 100 may be configured to hold a first layer of a composite precursor powder 1 in a powder bed 331.

The first layer may be formed by spreading a thin layer of the composite precursor powder 1 using a doctor blade or roller 310. For example, the blade or roller 310 may spread a thin layer of the composite precursor powder 1 from a supply bed 321 to the powder bed 331. The composite precursor powder 1 may be pre-heated, for example, by heaters in at least one of the supply bed 321 and/or the powder bed 331. For example, the composite precursor powder 1 may be pre-heated to about the reaction temperature.

In other implementations, the first layer may be formed by spraying. For example, the first layer may be formed by gas-assisted slurry deposition of the composite precursor powder 1, such as via high-volume low-pressure (HVLP) gas-assisted slurry spray deposition. The first layer may be formed by one or more passes of the HVLP sprayer. That is, the first layer may include one or more layers of the composite precursor powder 1.

The first layer may have a thickness from about 10 μm to about 1 mm. For example, the first layer may have a thickness from about 10 μm to about 1000 μm, from about 100 μm to about 500 μm, and from about 100 μm to about 250 μm. In other implementations, the first layer may have a thickness of about 100 μm, of about 170 μm, and of about 250 μm.

The first layer may be formed under vacuum or within an inert atmosphere. For example, the reaction chamber 100 may be evacuated or purged with an inert gas 402 before forming the first layer. In some implementations, substantially all of the air within the reaction chamber 100 is removed before forming the first layer. In other implementations, substantially all of the air within the reaction chamber 100 is replaced with an inert gas 402, such as argon, before forming the first layer. The reaction chamber 100 may be substantially free of oxygen before forming the first layer. The reaction chamber 100 may be substantially free of water before forming the first layer. For example, the reaction chamber 100 may contain less than 15 ppb oxygen or water.

Operation 820 includes heating the composite precursor powder 1 in the first layer. The first layer may be heated within the reaction chamber 100. In other implementation, only a portion of the first layer may be heated. In some implementations, the reaction chamber 100 may be a reaction furnace or the build chamber in an additive manufacturing machine. In other implementations, the reaction chamber 100 is part of an SLRS machine. The reaction chamber 100 may include a separate heating system, such as a substrate heater or a laser heating system. For example, as illustrated in FIG. 3, the system 10 may include a laser source 200 configured to heat at least a portion of the first layer using a laser beam 211. In some implementation, the laser beam 211 heats only some of the composite precursor powder 1 in the first layer.

The laser source 200 may have a laser power from about 0.1 watts to about 1000 watts. The laser source 200 may have a focal beam diameter from 10 μm to 10 mm with scan spacing of similar size as the spot size/beam diameter. The wavelength may range from 20 μm to 100 nm. The laser may pulsed or continuous.

The composite precursor powder 1 in the first layer or powder bed 331 may be heated to a reaction temperature. The reaction temperature may vary according to one of the non-oxide ceramic, a reactant gas, a desired speed for the conversion process, the metal or metalloid, the oxide, and the like. In one implementation, the reaction temperature is from about 100° C. to about 1000° C. In other implementation, the reaction temperature is up to about 3000° C. For example, the composite precursor powder 1 in the first layer may be heated up to about 800° C., up to about 900° C., and up to about 1000° C. In other implementations, when the reaction does not use methane, which can deposit carbon, the upper limit for the reaction temperature may be dictated by the phase diagram and the decomposition temperate of the precursors, for example, the metal or metalloid and the oxide. In those implementations, the reaction temperature may be up to about 2000° C.

In some implementations, the reaction temperature corresponds to the reaction temperature needed for gas-solid SLRS reactions according to the metal or metalloid and oxide in the composite precursor powder 1.

In other implementations, the reaction temperature corresponds to the reaction temperature needed for gas-liquid SLRS reactions according to the metal or metalloid and oxide in the composite precursor powder 1. For example, the reaction temperature may be configured to melt at least one of the metal or metalloid and the oxide. In some implementations, melting the metal or metalloid allows the molten metal or metalloid to infiltrate the oxide during a conversion operation.

The composite precursor powder 1 in the first layer may be heated to the reaction temperature for a predetermined amount of time (dwell time). For example, the composite precursor powder 1 in the first layer may be heated to the reaction temperature for about fractions of a second, or even milliseconds or less, according to the spot size of a laser to several minutes for general AM processing. For example, an area of the composite precursor powder 1 in the first layer may be heated to the reaction temperature for about 1 ms by laser irradiation. In other implementation the laser beam may be continuously moving with a continuous or pulsed irradiation such that the necessary reaction temperature is reached. The wavelength of the laser may be selected such that it facilitates rapid heating and energy absorption by the constituents of the composite precursor powder 1.

Operation 830 include exposing the composite precursor powder in the first layer to a reactant gas. The reactant gas 401 may include a reactant source corresponding to the non-oxide ceramic to be created. For example, the reactant gas 401 may include a carbon source, such as methane (CH₄), to make a carbide, a nitrogen source, such as ammonia (NH₃), to form a nitride, a silicon source, such as SiH₄, to make a silicide, and a boron source, such as diborane (B₂H₆) or BH₃, to make a boride.

The reactant gas 401 may include a diluent or inert gas, such as argon. The reactant gas 401 may include hydrogen. The reactant gas 401 may be substantially free of oxygen. The reactant gas 401 may be substantially free of water. For example, the reactant gas 401 may contain less than 15 ppb oxygen or water.

The reactant gas 401 may consist essentially of the reactant source. For example, the reactant gas 401 may consist essentially of methane (CH₄), ammonia (NH₃), or diborane (B₂H₆). The reactant gas 401 may consist essentially of the reactant source and the diluent or inert gas. The reactant gas 401 may consist essentially of the reactant source, the diluent or inert gas, and hydrogen.

In one implementation, the reactant gas 401 is introduced to the reaction chamber 100 after the composite precursor powder 1 in the first layer is heated to the reaction temperature. In other implementations, the reactant gas 401 is introduced to the reaction chamber 100 before the composite precursor powder 1 in the first layer is heated to the reaction temperature or as the composite precursor powder 1 in the first layer is heated to the reaction temperature.

The reactant gas 401 may generate a pressure within the reaction chamber 100. For example, the reactant gas 401 may generate a pressure from about 0.1 atm to about 10 atm within the reaction chamber 100.

The reactant gas 401 may flow through the reaction chamber at a particular flow rate. The flow rate may be used to refresh the reactant gas 401 and the atmosphere within the reaction chamber 100. The flow rate may also be used to remove by-products during the creation of the non-oxide ceramic. For example, the reactant gas 401 may have a flow rate from about 0 to about 1000 standard cubic centimeters per minute (SCCM) thought the reaction chamber 100. For example, the reactant gas 401 may have a flow rate of about 100, of about 250, and of about 400 SCCM.

The composite precursor powder 1 in the first layer may be exposed to the reactant gas 401 for a desired period of time. For example, the composite precursor powder 1 in the first layer may be exposed to the reactant gas 401 for a desired period of time after the reaction temperature is reached, and/or after a desired pressure or flow rate is achieved.

The composite precursor powder 1 in the first layer may be exposed to the reactant gas 401, without limitations, for up to 0.1 hours, 0.2 hours, 0.5 hours, up to 1 hour, up to 2 hours, up to 3 hours, up to 4 hours, up to 6 hours, up to 12 hours, and up to 24 hours. In some implementations, the first layer may be exposed to the reactant gas 401 for over 24 hours. For example, the exposure time may be fractions of a second to minutes under laser processing, according to beam intensity and spot size.

After heating the composite precursor powder 1 in the first layer to the reaction temperature and exposing it to the reactant gas 401, at least a portion of the composite precursor powder 1 in the first layer is converted to a non-oxide ceramic 600.

In some implementations, only heated portions of the composite precursor powder 1 in the first layer that are exposed to the reactant gas 401 are converted to a non-oxide ceramic 600. For example, only portions of the composite precursor powder 1 heated by the laser 200 to the reaction temperature may be converted to the non-oxide ceramic 600 when exposed to the reactant gas 401, while portions of the composite precursor powder 1 not heated to the reaction temperature are not converted to a non-oxide ceramic 600.

In order to create larger or multilayered non-oxide ceramic objects, a second layer of composite precursor powder 1 may be formed and converted to the non-oxide ceramic 600 in operations 840-860 similar to operations 810-830 described above.

For example, operation 840 may include forming a second layer of the composite precursor powder 1 over the first layer. The second layer may be formed after at least a portion of the composite precursor powder 1 in the first layer has been converted to a non-oxide ceramic 600.

The second layer may be formed by spreading a thin layer of the composite precursor powder 1 using doctor blades or rollers 310 over the first layer. Alternatively, the second layer may be formed over the first layer by HVLP gas-assisted slurry spray deposition.

The second layer may have a thickness similar to that of the first layer. In other implementations, the second layer may have a different thickness than that of the first layer.

To promote reaction-bonding and inter-layer adhesion, in some implementations, the second layer may be added before the first layer is fully converted to a non-oxide ceramic 600. For example, the second layer may be added when portions of the composite precursor powder 1 in the first layer configured to be converted to a non-oxide ceramic 600 are 80% converted, 90% converted, and/or 95% converted. In one implementation, the second layer is deposited when a portion of the composite precursor powder 1 in the first layer is 80%, 90%, and/or 95% converted to a non-oxide ceramic 600.

While not bound to any particular theory, the inventors believe that when the composite precursor powder 1 in the second layer is converted it will reaction bond with the composite precursor powder 1 in the first layer to enhance inter-layer adhesion.

In some implementations, the second layer of the composite precursor powder is formed over the first layer when at least 95% of the portion of the composite precursor powder in the first layer is converted to a non-oxide ceramic.

The second layer of the composite precursor powder may be formed over the first layer when at least 80%, 90%, and/or 95% of the portion of the composite precursor powder in the first layer is converted to a non-oxide ceramic.

In other implementations, the second layer of the composite precursor powder is formed over the first layer when the portion of the composite precursor powder in the first layer is fully converted to a non-oxide ceramic. For example, the second layer of the composite precursor powder may be formed over the first layer when substantially all of the portion of the composite precursor powder in the first layer is converted to a non-oxide ceramic or when about 100% of the portion of the composite precursor powder in the first layer is converted to a non-oxide ceramic.

In some implementations, the composition of the composite precursor powder 1 in the second layer may be different than the composition of the composite precursor powder 1 in the first layer. For example, the first layer may have a Ti/TiO₂ composite precursor powder 1 and the second layer may have a Si/SiO₂ composite precursor powder 1.

Operation 850 may include heating the composite precursor powder 1 in the second layer. For example, the composite precursor powder 1 in the second layer may be heated to the reaction temperature after at least a portion of the composite precursor powder 1 in the first layer has been converted to a non-oxide ceramic 600.

Operation 860 may include exposing the composite precursor powder 1 in the second layer to the reactant gas 401. For example, the composite precursor powder 1 in the second layer may be exposed to the reactant gas 401 after at least a portion of the composite precursor powder 1 in the first layer has been converted to a non-oxide ceramic 600.

After heating the composite precursor powder 1 in the second layer to the reaction temperature and exposing it to the reactant gas 401, at least a portion of the composite precursor powder 1 in the second layer is converted to a non-oxide ceramic 600.

In some implementations, only heated portions of the composite precursor powder 1 in the second layer that are exposed to the reactant gas 401 are converted to a non-oxide ceramic 600. For example, only portions of the composite precursor powder 1 heated by the laser 200 to the reaction temperature may be converted to the non-oxide ceramic 600 when exposed to the reactant gas 401, while portions of the composite precursor powder 1 not heated to the reaction temperature are not converted to a non-oxide ceramic 600.

Accordingly, the present disclosure provide a method of adjusting a volume of a non-oxide ceramic object created from a composite precursor powder, including adjusting a molar ratio of the composite precursor powder, wherein the composite precursor powder comprises a metal or metalloid, and an oxide, and wherein a molar ratio of the metal or metalloid to the oxide is configured to balance a volume change of the metal or metalloid when converted to a non-oxide ceramic and a volume change of the oxide when converted to a non-oxide ceramic.

### EXAMPLES

Aspects of the present disclosure can be further understood by referring to the following examples. The examples are illustrative, and are not intended to be limiting.

### Example 1

A composite precursor powder according to implementations of the disclosure was prepared as follows: an 86/14 molar ratio of chromium (Cr) powder (Alfa Aesar, APS<10 μm, 99.2%) and chromium oxide (Cr₂O₃) powder (Alfa Aesar, APS<44 μm, 99%) was combined into a mixture. The mixture was ball milled in a methanol suspension inside a tungsten carbide jar with a Planetary Ball Mill PM 100 (Retsche, Haan, 42,781, Germany). Milling occurred over a total of 12 hours using 5 min on/off cycles to reduce particle sizes and to homogenize the mixture in order to create a Cr/Cr₂O₃ composite precursor powder. The particle size of the mixture was reduced to a micrometer and nanometer scale. In particular, the average particle size for Cr was about 5-20 μm and the average particle size for Cr₂O₃ was about 100 nm to 1 pm. While not bound to any particular theory, the inventors believe that the small particle size of the metal/metal-oxide mixtures enhances gas-phase mass transport through the volume as well as surface diffusion along particle boundaries within the micro/nanoscale Cr/Cr₂O₃ network during the conversion reaction to Cr₃C₂.

The homogeneity of the ball-milled Cr/Cr₂O₃ composite precursor powder was assessed prior to conversion to Cr₃C₂ using scanning electron microscopy (SEM) with back-scattered electron (BSE) analysis (Tescan Mira 3 GM Scanning Electron Microscope; Kohoutovice, 62,300, Czech Republic). In particular, the Cr/Cr₂O₃ composite precursor powder was sprayed on an Inconel 600 substrate as described below, and SEM and SEM-BSE micrographs were taken of the layer of Cr/Cr₂O₃ composite precursor powder to determine a homogeneity of the mixture. Because the number of backscattered electrons is proportional to the mean atomic number of the elemental components, bright particles in BSE images may be associated with materials having a higher average atomic number.

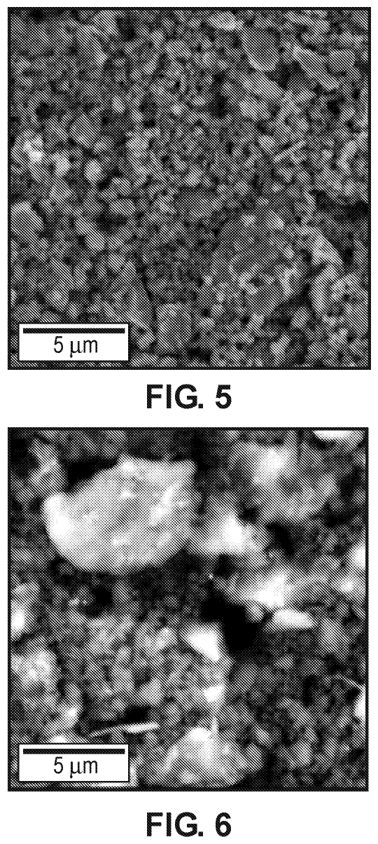

FIG. 5 illustrates a SEM micrograph of a composite precursor powder according to an implementation. FIG. 6 illustrates a SEM-BSE micrograph of the composite precursor powder of FIG. 5 according to an implementation. As illustrated in FIGS. 5-6, the Cr/Cr₂O₃ composite precursor powder is homogenous and well-mixed. In particular, as illustrated in FIG. 5, the micrometer-scale Cr particles (average particle size of about 5-20 μm) are well mixed among the nanometer-scale Cr₂O₃ particles (average particle size of about 100nm to 1 μm). As illustrated in greater detail in FIG. 6, the larger, brighter, Cr particles are at least partially surrounded, and in many cases, fully surrounded by the smaller, nanoscale Cr₂O₃ particles.

### Example 2

A non-oxide ceramic object was prepared using the composite precursor powder of Example 1 according to implementations of the disclosure as follows: an air-assisted slurry deposition method was used to deposit the Cr/Cr₂O₃ composite precursor powder of example 1. In particular, a HUSKEY HVLP spray gun (Model #H4840GHVSG) was used to deposit a methanol suspensions of the Cr/Cr₂O₃ composite precursor powder at room temperature using an internal air pressure of 103 kPa. A slurry mix ratio of 72 weight % of the Cr/Cr₂O₃ composite precursor powder (86/14 molar ratio) in methanol was used to deposit a 250 μm layer of the Cr/Cr₂O₃ composite precursor powder on Inconel 600 substrates (76.2 mm×25.4 mm×3.175 mm). The 250 μm layer was created using five passes of the HVLP sprayer. The Inconel substrates were masked prior to spray deposition to ease sample handling. The masking resulted in samples with an area of 25.4 mm×25.4 mm. As illustrated in FIGS. 5-6, the layer of Cr/Cr₂O₃ composite precursor powder was well mixed and homogenous.

The layers of Cr/Cr₂O₃ composite precursor powder on the sample Inconel substrates were then process at a reaction temperature of 950° C. for 0.1 hours in a horizontal quartz tube furnace (CM Furnace, 60×64×1300 mm) in reactant gas atmospheres with the following compositions:
Reactant Gas I: 80 volume % Ar, 20 volume % CH₄, at 250 SCCM;
Reactant Gas II: 76 volume % Ar, 4 volume % H₂, 20 volume % CH₄, at 250 SCCM.

In both cases, a total flow rate was maintained at 250 SCCM during heating following a three hour purge (400 SCCM) with 100 volume % Ar for Reactant Gas I and 95/5 volume % Ar/H₂ for Reactant Gas II. Ramp up and ramp down rates were set at 1000° C./h with the reactant gas composition remaining unchanged throughout the heating, reaction dwell, and cooling portions of the cycle.

High purity CH₄ and Ar (both 99.995%) were used in conjunction with an in-line Restek High-Capacity O₂ and moisture trap capable of reducing 02 and H₂O contamination to less than 15 ppb from the incoming reactant gas flow. Accordingly, the atmospheres within the furnace was substantially free of O₂ and H₂O contamination during a conversion process.

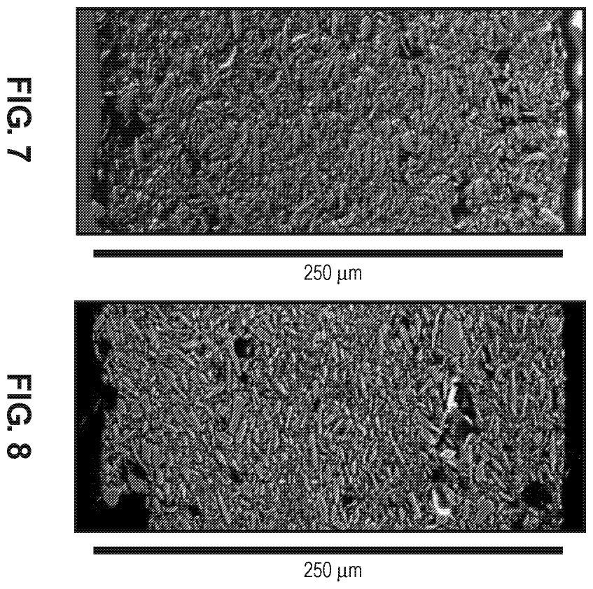

FIG. 7 illustrates an SEM micrograph of a composite precursor powder before conversion to a non-oxide ceramic according to an implementation. FIG. 8 illustrates an SEM micrograph of the composite precursor powder of FIG. 7 after conversion to a non-oxide ceramic according to an implementation. In particular, FIGS. 7-8 illustrate a cross-section of the 250 μm layer of the Cr/Cr₂O₃ composite precursor powder on an Inconel 600 substrate before (FIG. 7) and after (FIG. 8) conversion to a Cr₃C₂ non-oxide ceramic (Reactant Gas II). As illustrated in FIGS. 7-8, the conversion of the Cr/Cr₂O₃ composite precursor powder to a Cr₃C₂ non-oxide ceramic was substantially isovolumetric. The initial 250 μm thickness of the Cr/Cr₂O₃ composite precursor powder layer in FIG. 7 remains unchanged after having been converted to a 250 μm Cr3C₂ non-oxide ceramic in FIG. 8.

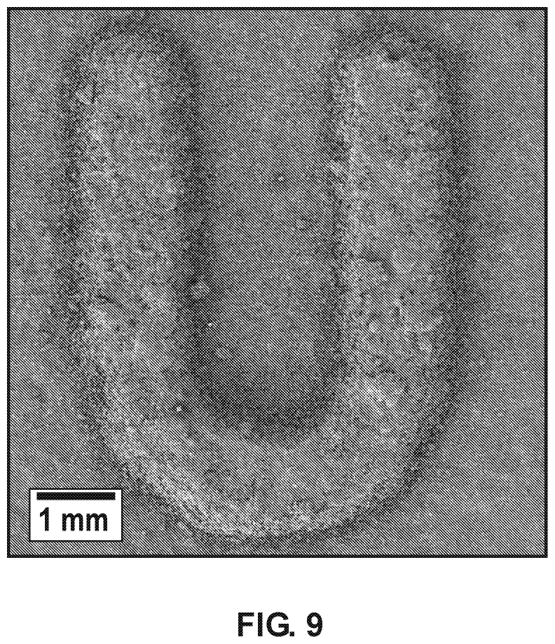

FIG. 9 illustrates an SEM micrograph of a patterned Cr3C₂ sample formed from a composite precursor powder according to an implementation. In particular, FIG. 9 illustrates the results of a selectively masked deposition technique using an HVLP sprayer. As illustrated in FIG. 9, Cr3C₂ structures to approximately 1 mm sizes can be formed by masked deposition using an HLVP spraying. In other implementations, a laser may be used for patterning and creating Cr3C₂ structures from the composite precursor powder, with a beam diameter of the laser patterning dictating the precision of the three-dimensional structure.

Accordingly, the present disclosure provides composite precursor powders for the isovolumetric formation of non-oxide ceramics. In some implementations, the composite precursor powder reduces thermally induced stresses and allows for reaction bonding to serve as a primary mechanism for particle adhesion, increasing the mechanical integrity of the non-oxide ceramic. In other embodiments, the porosity and thickness of the non-oxide ceramic is maintained after the formation of the non-oxide ceramic from the composite precursor powders.

While FIGS. 7-8 illustrate a substantially isovolumetric conversion of the composite precursor powder layer to a non-oxide ceramic, the present disclosure is not limited thereto. And, as described above, the molar ratio of the metal or metalloid to the oxide in the composite precursor powder may be varied to control a volume change of the conversion process. For example, if a denser a non-oxide ceramic was desired, the ratio may be modified to increase the amount of metal or metalloid in the composite precursor powder.

### Example 3

A composite precursor powder according to implementations of the disclosure was prepared as follows: a 67/33 molar ratio of chromium (Cr) powder (Alfa Aesar, APS<10 μm, 99.2%) and chromium oxide (Cr₂O₃) powder (Alfa Aesar, APS<44 μm, 99%) was combined into a mixture. The mixture was ball milled in a methanol suspension inside a tungsten carbide jar with a Planetary Ball Mill PM 100 (Retsche, Haan, 42,781, Germany). Milling occurred over a total of 12 hours using 5 min on/off cycles to reduce particle sizes and to homogenize the mixture in order to create a Cr/Cr₂O₃ composite precursor powder. The particle size of the mixture was reduced to a micrometer and nanometer scale. In particular, the average particle size for Cr was about 5-20 μm and the average particle size for Cr₂O₃ was about 100 nm to 1 μm.

A laser patterned non-oxide ceramic object was prepared using the composite precursor powder according to implementations of the disclosure as follows: an air-assisted slurry deposition method was used to deposit the Cr/Cr₂O₃ composite precursor powder of Example 3. In particular, the HUSKEY HVLP spray gun (Model #H4840GHVSG) was used to deposit a methanol suspension of the Cr/Cr₂O₃ composite precursor powder at room temperature using an internal air pressure of 103 kPa. Again, a slurry mix ratio of 72 weight % of the Cr/Cr₂O₃ composite precursor powder (67/33 molar ratio) in methanol was used to deposit a 250 μm layer of the Cr/Cr₂O₃ composite precursor powder on an Inconel 600 substrate (76.2 mm×25.4 mm×3.175 mm). The 250 μm layer was created using five passes of the HVLP sprayer. The Inconel substrates were masked prior to spray deposition to ease sample handling.

Laser heating was supplied by a 5.5 W (optical output, beam diameter ˜250 μm), 450 nm diode laser coupled to a computerized CNC laser stage. The computer-controlled laser enabled X and Y axis control of the beam path. Software enabled control over the selective laser irradiation, the laser power, and scan speed scan speed which is dictated by the length of time the beam is fixated on a single pixel corresponding to an image in the software interface. The CNC stage has a working of 1500×1500 mm. Durations of scan speed within the software ranged from 0.75 mm/s-75 mm/s. The laser was used to selectively convert the sample contained in flowing 100 vol. % ammonia NH₃ gas contained within a transparent reaction vessel.

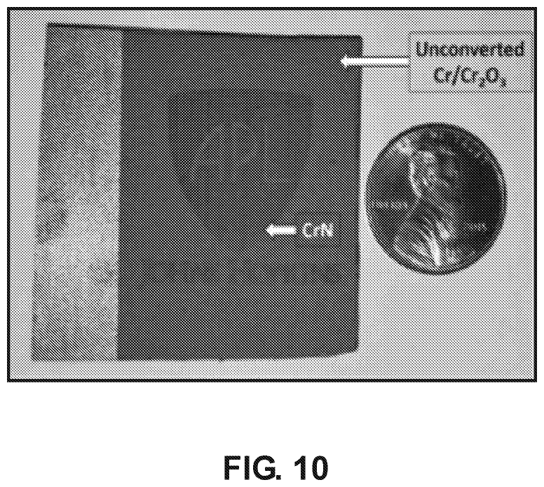

FIG. 10 illustrates a non-oxide ceramic according to an implementation. In particular, FIG. 10 illustrates an APL logo created of a chromiun nitride according to Example 3 above (67/33 Cr/Cr₂O₃ composite precursor powder, 10 μm Cr, <1 μm Cr₂O₃ deposited by HVLP spray; converted using 10% power, ˜3 mm/s scan speed in 100% NH₃).

### Example 4

A composite precursor powder according to implementations of the disclosure was prepared as follows: an 85/15 molar ratio of titanium (Ti) powder (−325 mesh) and titanium oxide (TiO₂) powder (<10) was combined into a mixture. The mixture was combined by roller mixing for 12hrs. A single component powder containing only titanium (Ti) powder (−325 mesh) was similarly prepared.

Circular samples areas (25.4 mm diameter) were created by screening the Ti and 85/15 Ti/TiO₂ powders into thin 100 μm layers using a doctor blade on quartz substrate (40 mm×40 mm). Subsequent to layer deposition, each composition of either pure Ti powder or the isovolumetric Ti/TiO₂ composite precursor powder were situated within the quartz reaction vessel for laser induced conversion. The vessel containing the samples was then purged for 3 hrs using high purity argon prior to the addition of 100% CH₄ (flow rate 250 SCCM).

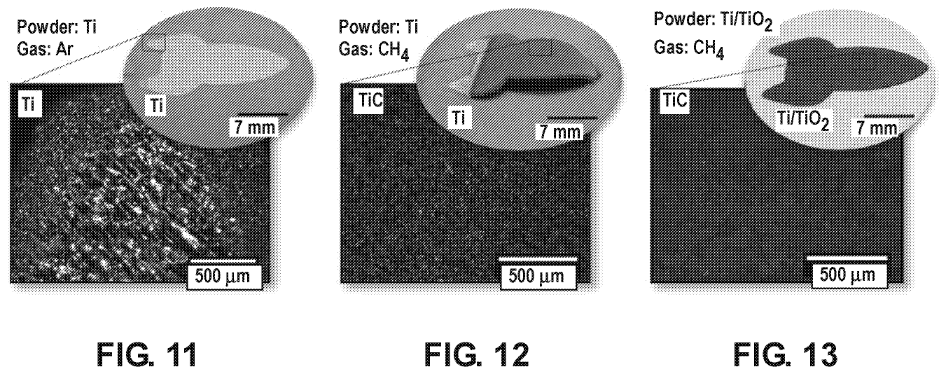

Laser heating was supplied by a 5.5 W (optical output, beam diameter ˜250 μm), 450 nm diode laser coupled to a computerized CNC laser stage. The computer-controlled laser enabled X and Y axis control of the beam path. Software enabled control over selective laser irradiation, laser power, and scan speed scan speed which is dictated by the length of time the beam is fixated on a single pixel corresponding to an image in the software interface. Durations of scan speed within the software ranged from 0.75 mm/s-75 mm/s. FIGS. 11-12 illustrate a volumetric expansion of titanium-based powders. FIG. 13 illustrates a volumetric expansion of a titanium-based composite precursor powder according to an implementation. As illustrated in FIGS. 11-13, a “rocket ship” layer geometry was selectively converted in the Ti powder subjected to flowing Ar (inert) and 100% CH₄ gas. The same “rocket ship” geometry was selectively patterned in the isovolumetric 85/15 mol. Ti/TiO₂ composite precursor powder under the same reaction conditions. The sample composed of Ti powder laser irradiated in argon demonstrated sintering behavior of the titanium particles, but no chemical conversion or gas-solid reactivity to TiC. The sample composed of Ti irradiated in the presence of 100% CH₄ converted to TiC, but showed volumetric expansion, causing the layer to delaminate and bow off of the quartz substrate (FIG. 12). In contrast, as illustrated in FIG. 13, the 85/15 mol. Ti/TiO₂ composite precursor powder subjected to SLRS processing in 100% CH₄ converted nearly isovolumetrically to the intended TiC non-oxide, with minimal mechanical stress, cracking, and displaying no layer delamination. This is apparent from the optical image micrographs in FIGS. 11-13 showing the microstructures of the resulting structures.

The present disclosure has been described with reference to exemplary implementations. Although a few implementations have been shown and described, it will be appreciated by those skilled in the art that changes can be made in these implementations without departing from the principles and spirit of preceding detailed description. It is intended that the present disclosure be construed as including all such modifications and alterations insofar as they come within the scope of the appended claims or the equivalents thereof.

What is claimed, is:

1. A composite precursor powder, comprising:
one or more metals or metalloids; and
one or more oxides,
wherein a molar ratio of the one or more metals or metalloids to the one or more oxides is from about 1:0.01 to about 1:4, and
wherein the molar ratio of the one or more metals or metalloids to the one or more oxides is configured according to a desired volumetric change of the composite precursor powder when converted to a non-oxide ceramic.

2. The composite precursor powder of claim 1, wherein the molar ratio of the one or more metals or metalloids to the one or more oxides is configured to balance a volume change of the one or more metals or metalloids when converted to a non-oxide ceramic and a volume change of the one or more oxides when converted to a non-oxide ceramic.

3. The composite precursor powder of claim 1, wherein the molar ratio of the one or more metals or metalloids to the one or more oxides is configured to produce a substantially isovolumetric non-oxide ceramic.

4. The composite precursor powder of claim 1, wherein the molar ratio of one or more metals or metalloids to the one or more oxides is configured to produce a non-oxide ceramic with one of a larger volume than the composite precursor powder and a smaller volume than the composite precursor powder.

5. The composite precursor powder of claim 1, wherein the molar ratio of the one or more metals or metalloids to the one or more oxides is one of about 21:79, 33:66, 41:59, 67:33, 84:16, 86:14, 87:13, 89:11, 90:10, 96:04: and 97:03.

6. The composite precursor powder of claim 1, wherein a mole fraction of the one or more metals or metalloids in the composite precursor powder is from about 0.01 to 0.99.

7. The composite precursor powder of claim 1, wherein a mole fraction of the one or more metals or metalloids in the composite precursor powder is one of about 0.21, 0.33, 0.41, 0.67, 0.84, 0.86, 0.87, 0.89, 0.90, 0.96, and 0.97.

8. The composite precursor powder of claim 1, wherein the composite precursor powder does not include a binder, and
wherein the composite precursor powder consists essentially of the one or more metals or metalloids and the one or more oxides.

9. The composite precursor powder of claim 1, wherein the non-oxide ceramic is a composite non-oxide ceramic.

10. The composite precursor powder of claim 1, wherein the one or more metals or metalloids comprise one or more metals encompassed by groups 2-6 and periods 2-6 of the periodic table, and
wherein the one or more oxides comprise one or more oxides of a metal or metalloid encompassed by groups 2-6 and periods 2-6 of the periodic table.

11. The composite precursor powder of claim 1, wherein at least one of the one or more oxides in the composite precursor powder corresponds to at least one of the one or more metals or metalloids.

12. The composite precursor powder of claim 1, wherein the one or more metals or metalloids comprise at least one of chromium (Cr), titanium (Ti), silicon (Si), and zirconium (Zr), and wherein the one or more oxides comprises at least one of chromium oxide, titanium oxide, silicon oxide, and zirconium oxide.

13. The composite precursor powder of claim 1, wherein the composite precursor powder is a substantially homogenous mixture.

14. The composite precursor powder of claim 1, wherein the one or more metals or metalloids have an average particle size from about 100 nm to about 100 μm, wherein the one or more oxides have an average particle size from about 100 nm to about 100 μm, and
wherein the one or more metals or metalloids are substantially surrounded by the oxide.

15. The composite precursor powder of claim 1, wherein the composite precursor powder is configured for use in selective laser reaction sintering to convert into at least one of a carbide, nitride, boride, and silicide non-oxide ceramic.

16. A method of making a non-oxide ceramic object from a composite precursor powder, comprising:
forming a first layer of a composite precursor powder, wherein the composite powder comprises one or more metals or metalloids and one or more oxides;
heating the composite precursor powder in the first layer; and
exposing the composite precursor powder in the first layer to a reactant gas,
wherein at least a portion of the composite precursor powder in the first layer is converted to a non-oxide ceramic after being heated and exposed to the reactant gas, and
wherein a molar ratio of the one or more metals or metalloids to the one or more oxides in the composite precursor powder is configured according to a desired volumetric change of the composite precursor powder when converted to the non-oxide ceramic.

17. The method of claim 16, further comprising:
forming a second layer of the composite precursor powder over the first layer;
heating the composite precursor powder in the second layer; and
exposing the composite precursor powder in the second layer to the reactant gas,
wherein at least a portion of the composite precursor powder in the second layer is converted to a non-oxide ceramic after being heated and exposed to the reactant gas.

18. The method of claim 17, wherein the second layer of the composite precursor powder is formed over the first layer when at least 95% of the portion of the composite precursor powder in the first layer is converted to a non-oxide ceramic.

19. The method of claim 17, wherein the second layer of the composite precursor powder is formed over the first layer when substantially all of the portion of the composite precursor powder in the first layer is converted to a non-oxide ceramic.

20. The method of claim 16, wherein the first layer has substantially the same volume after the first layer is converted to the non-oxide ceramic as when it was formed from the composite precursor powder.

21. The method of claim 16, wherein the second layer has substantially the same volume after the second layer is converted to the non-oxide ceramic as when it was formed from the composite precursor powder over the first layer.

22. A non-oxide ceramic object created from a composite precursor powder according to claim 1.
